(19) United States
(12) Patent Application Publication
(10) Pub. No.: US 2006/0233603 A1
(43) Pub. Date: Oct. 19, 2006

(54) Display device frame and bezel fastener, fastening system and fastening method

(76) Inventor: Michel Alain Cadio, Carmel (FR)

Correspondence Address: THOMSON LICENSING INC., PATENT OPERATIONS, PO BOX 5312, PRINCETON, NJ, 08543-5312, US

(21) Appl. No.: 11/109,031

(22) Filed: Apr. 19, 2005

(51) Int. Cl. B25G 3/18

(52) U.S. Cl. 403/329

(57) ABSTRACT

The invention provides a fastener, fastening system and fastening method for use in mounting display screen assemblies to bezels of display device housings while avoiding the use of screws through the screen to secure the screen to the bezel. One embodiment of the invention provides a fastener comprising a first flange for engaging the display screen assembly and a second flange for engaging the bezel. An intermediate portion extends between the first and second flanges. At least a portion of the intermediate portion comprises a resiliently deformable material having sufficient deformability to permit deforming the fastener from an initial position to a second position to permit installation of the fastener. The resiliently deformable material has sufficient resilience to permit the fastener to substantially reform to the initial position after installation of the fastener. The initial position maintains the display panel assembly in contact with the bezel after installation of the fastener.

### FIELD OF THE INVENTION

The invention provides a fastening device and method that permits a display, such as a video display screen to be fastened to a bezel and mounted on a cabinet without causing stress to the display screen by penetration the display screen with affixing devices, such as for example, by screws.

### BACKGROUND OF THE INVENTION

Display screens, hereinafter “screens”, are employed in various products such as televisions for displaying video images. In a typical configuration for such products a display screen and a frame are assembled in a fitted relationship to each other providing a display screen and frame assembly. The display screen and frame assembly is then mounted to a bezel. The bezel, including the display screen and frame assembly, is mounted to a cabinet. The cabinet houses various electronics and optical components for providing an image for display upon the display screen.

The frame and bezel are typically formed with mounting holes, threaded holes, hooks or the likes, designed for securing the screen and frame assembly to the bezel and the bezel to the cabinet. Therefore, it is conventional to mount the screen and panel assembly to the bezel by means of screws or other affixing means that penetrate the screen. This penetration of the screen exerts stress upon the screen frequently having undesirable results.

### SUMMARY OF THE INVENTION

The present invention provides a structure in which deterioration of the display quality and reliability of a display device due to stress exerted by affixing devices that penetrate the screen are avoided.

### BRIEF DESCRIPTION OF THE DRAWINGS

Embodiments of the present invention will be described below in more detail, with reference to the accompanying drawings, in which like parts are represented with like numerals and wherein:

FIG. 1 is an exploded view of an example television type display device for describing various embodiments of the invention.

FIG. 2 is a perspective view of an example screen and frame assembly suitable for implementing various embodiments of the invention.

FIG. 3 is a front perspective view of an example bezel suitable for implementing embodiments of the invention.

FIG. 4 is an enlarged partial view of a front portion of the bezel of FIG. 3.

FIG. 5 is a front perspective view of the screen and frame assembly illustrated in FIG. 2 being inserted into the bezel illustrated in FIG. 3.

FIG. 6 is a rear perspective view showing the screen and frame of FIG. 2 inserted into the bezel of FIG. 3.

FIG. 7 is an end elevation view of an example fastener according to an embodiment of the invention.

FIG. 8 is a perspective view of a fastener according to one alternative embodiment of the invention.

FIG. 9 is a perspective view of a fastener according to one embodiment of the invention.

FIG. 10 is an end elevation view of the fastener illustrated in FIG. 9 including dimensions according to an embodiment of the invention.

FIG. 11 is an end elevation view of a fastener according to an alternative embodiment of the invention.

FIG. 12 illustrates a fastener according to an embodiment of the invention in a first position during installation of the fastener.

FIG. 13 illustrates a fastener according to an embodiment of the invention in position after installation of the fastener.

FIG. 14 is a partial cross sectional view of a screen and frame assembly according to one embodiment of the invention.

FIG. 15 is a flow chart illustrating a method fastening according to an embodiment of the invention.

FIGS. 16A-16B are pictorial illustrations of an example fastener according to an embodiment of the invention as it appears as it is rotated during installation (16A) and in position (16B) according to steps of a method of the invention.

### DETAILED DESCRIPTION

The terms “upper”, “lower”, “side”, “downward”, “upward” and so forth are used herein merely for convenience to describe the present invention and its parts as oriented in the drawings. It is to be understood, however, that these terms are in no way limiting to the invention since the invention is capable of being disposed in a wide variety of spatial orientations.

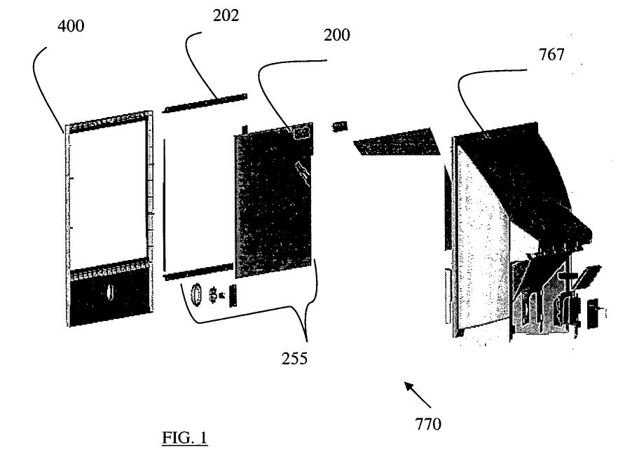

The invention provides a fastening device and fastening method for use in devices such as the display device 770 illustrated in FIG. 1. Display device 770 comprises a cabinet 767 for housing various electronics and optical components that provide images for display on screen 200. A screen 200 is typically assembled with a frame 202 to form a screen and frame assembly 255. The invention permits screen and frame assembly 255 to be fastened to a mounting assembly, for example a bezel 400, in a dimensionally stable way without causing stress to the screen 200 due to penetration of screen 200 by conventional affixing devices, for example, screws, pins, bolts and the like. Bezel 400, in turn, is mounted to cabinet 767 to provide an assembled display device for providing images for viewing on screen 200

Types of screens 200 to which the present invention apply include, but are not limited to, generally flat panels of the type found on Liquid Crystal Diode (LCD) Displays, Liquid Crystal on Silicon (LCOS) displays, Cathode Ray Tube (CRT) displays and the like.

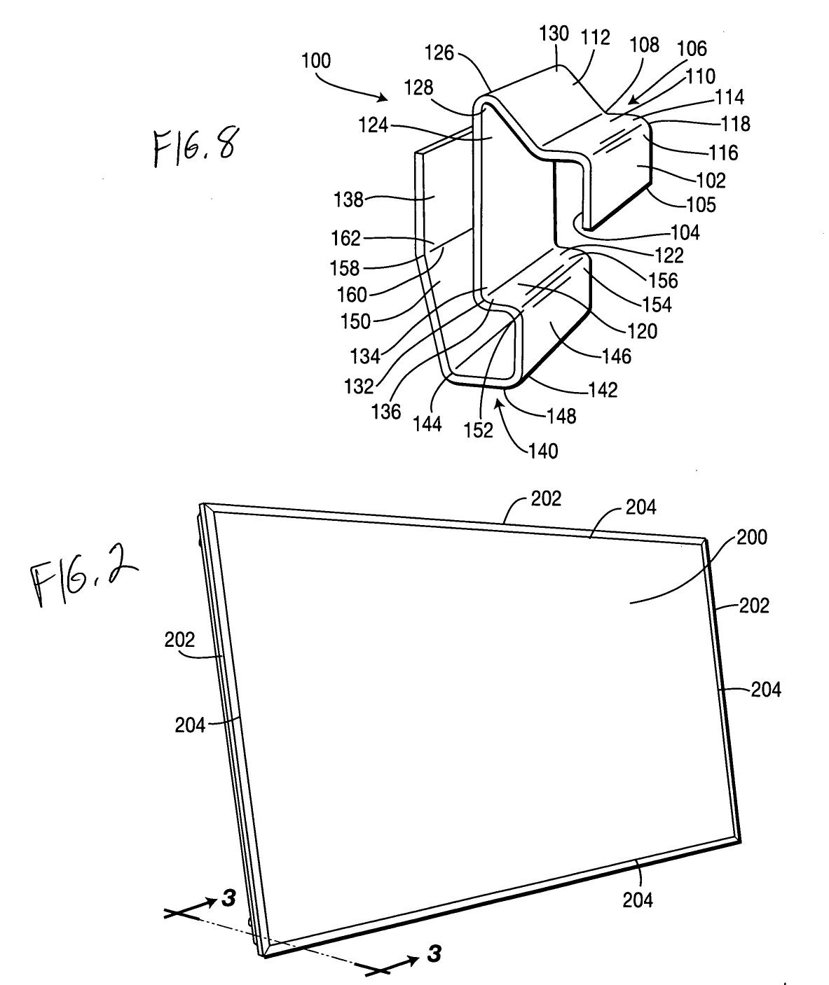

FIG. 2 is a perspective view of an example screen and frame assembly suitable for implementing various embodiments of the invention. The embodiment of screen 200 depicted in FIG. 2, is generally rectangular in shape. However, the invention is not limited in regard to screen shape. Screen and frame assembly 255 comprises frame 202 and screen 200. Frame 202 is attached to screen 200 around peripheral edges 204 of screen 200. According to various embodiments of the invention, frame 202 is made of material selected from the group comprising aluminum, steel, plastic, composite material, and other suitable materials.

FIG. 3 is a front perspective view of an example bezel 400 suitable implementing various embodiments of the invention. Bezel 400 is typically made of materials such as aluminum, steel, plastic, or composite materials. However, a variety of other materials are suitable for use in constructing bezels such as bezel 400.

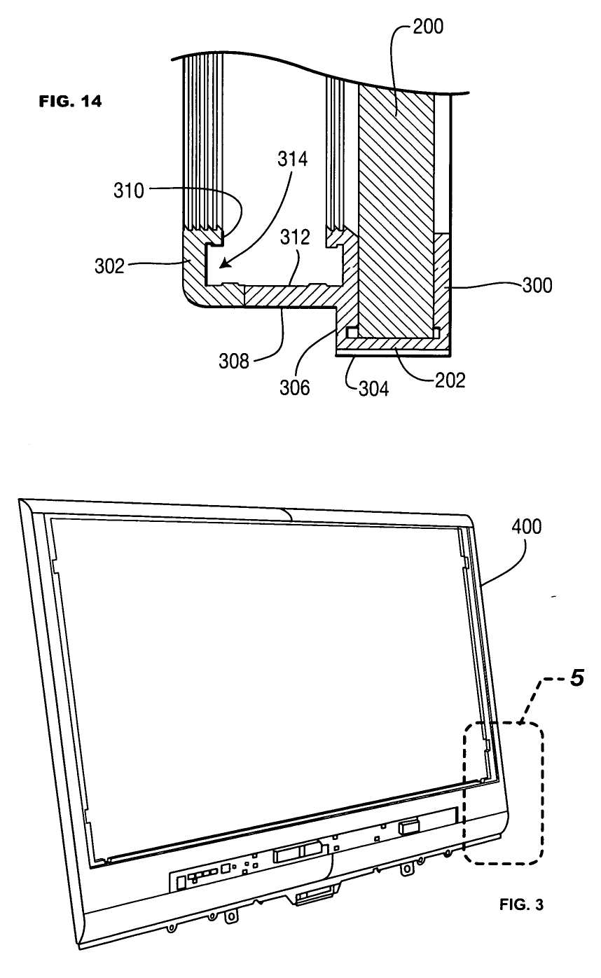

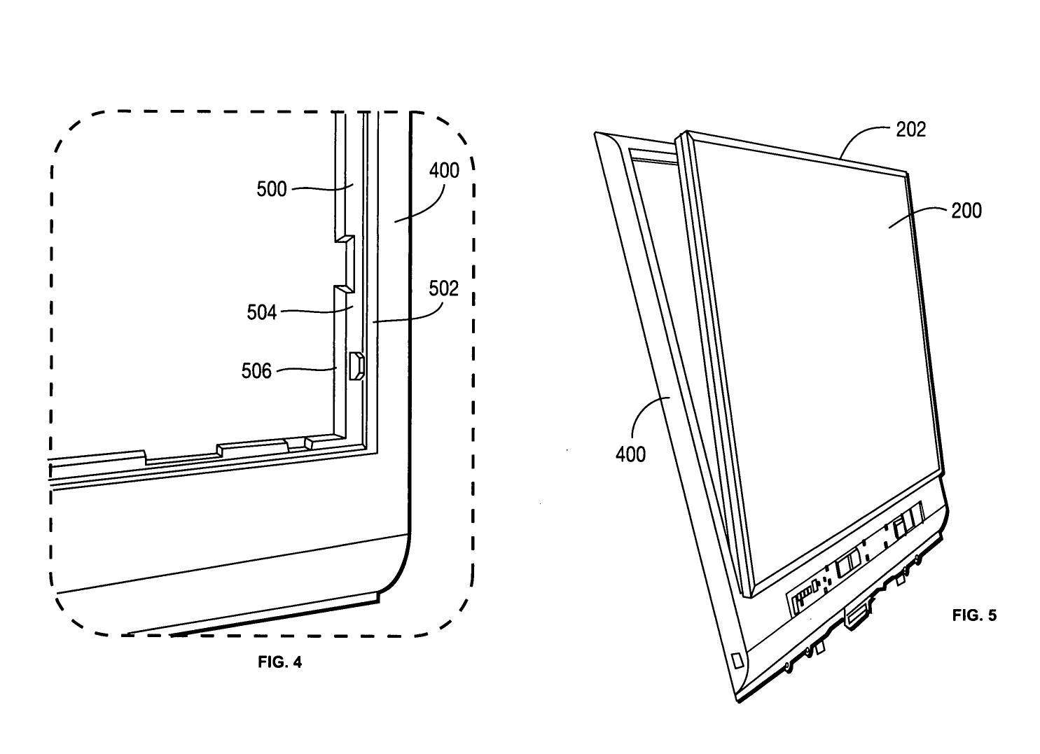

FIG. 4 is a partial view of a front portion 5 of bezel 400 of FIG. 3. According to an embodiment of the invention, bezel 400 includes a frame support member 500. In example embodiments of the invention, bezel surfaces 502, 504, 506 are configured for contacting frame 202 of screen and frame assembly 255 (illustrated, e.g., in FIG. 2) when screen and frame assembly 255 is installed in bezel 400. According to some embodiments of the invention, one or more notches 508, are provided to indicate to an installer the particular portions of the bezel to receive fasteners. In some embodiments of the invention, notches 508 are sized accordingly, such that a fastener is installable in a fitted relationship to notch 508 and the bezel 400.

FIG. 5 is a front perspective view of a screen and frame assembly 255 including screen 200 and frame 202, as illustrated in FIGS. 1 and 2. FIG. 5 shows screen and frame assembly 255 in a position partially installed into bezel 400.

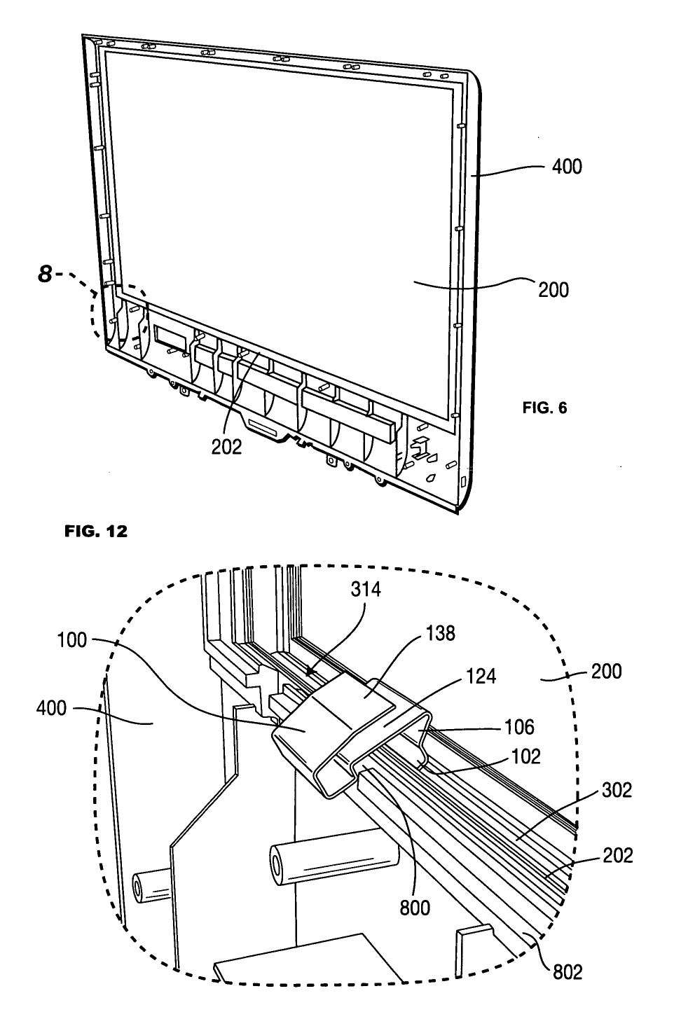

FIG. 6 is a rear perspective view showing the screen 200 and frame 202 of screen and frame assembly 255 (best illustrated in FIG. 2.) in position within an example bezel 400. A portion 8 of bezel 400 will be discussed in more detail herein in the context of describing a fastener according to an embodiment of the invention.

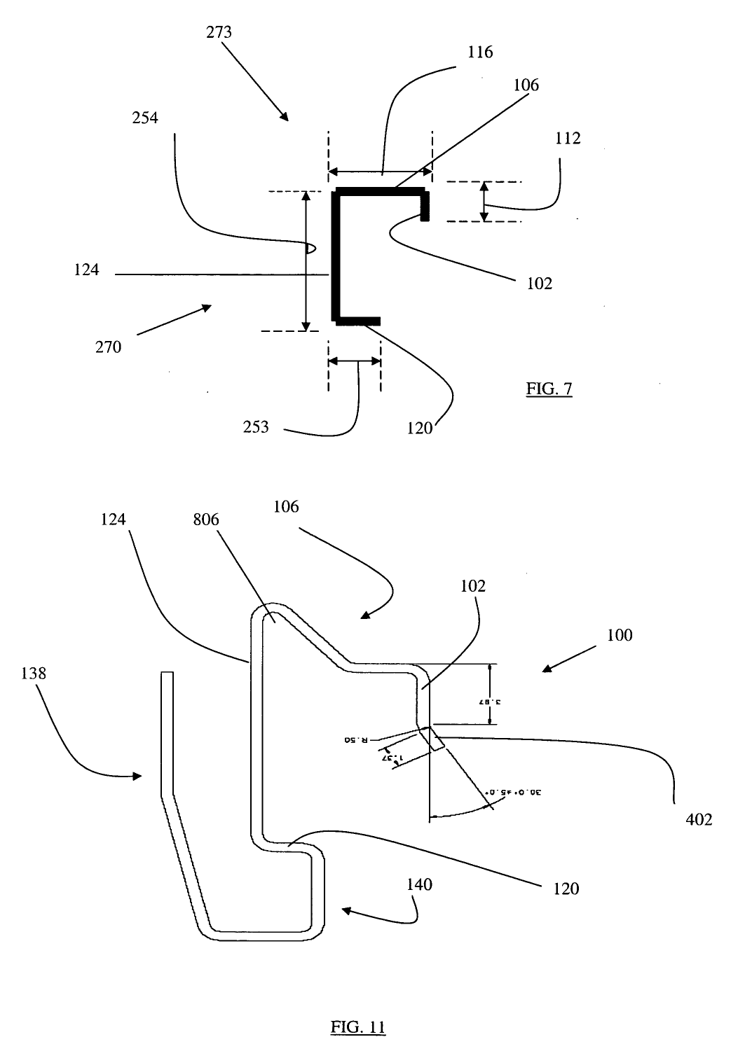

FIG. 7 is an end elevation view of a fastener 270 according to an embodiment of the invention. Fastener 270 fastens screen and frame assembly 255 to bezel 400 such that assembly 255 and bezel 400 are maintained in contact with each other in the fitting direction when fastener 270 is fully installed. In an installed position (example illustrated in FIG. 9) fasteners according to embodiments of the invention contact both screen and frame assembly 255 and bezel 400. In that manner, separating forces which would otherwise cause these components to become separated from each other during handling, transportation and operation during the lifetime of the display device, are overcome by the fasteners according to the various embodiments of the invention.

In various embodiments of the invention, a plurality of fasteners 270 are installed around the inside perimeter that is formed when screen and frame assembly 255 is inserted into bezel 400. A sufficient number of fasteners are installed to insure mechanical stability of the assembled display device throughout the lifetime of the display device. In one embodiment of the invention, at least 4 fasteners are employed. In other embodiments of the invention, a maximum of 6 fasteners are employed. Any number of fasteners are suitable for methods of the invention. The optimum number of fasteners for achieving a desired mechanical stability and integrity of the screen and of the screen and frame assembly and bezel when mounted to a cabinet will vary depending on size, weight, materials and other attributes of the particular display device used.

Fastener 270 comprises an intermediate portion 273 extending between first and second flanges 271 and 272. In the embodiment of the invention illustrated in FIG. 7, intermediate portion 273 comprises a crossing portion 106 and a body portion 124. In the orientation illustrated in FIG. 7, crossing portion 106 is generally perpendicular to body portion 124. However, the invention is not limited in regard to the angular relationship, nor to the shape of crossing portion 106 and body portion 124. Embodiments of the invention include crossing portions that generally describe bend, for example, a generally U shaped portion with body portion 124. Other embodiments of the invention include body portions 124 and crossing portions 106 having other shapes, for example W and M shapes. As long as the shape of intermediate portion 273 is such that contact is maintained between body portion 124 upon on bezel 400 and first flange 102 upon screen and frame assembly 255 in the fitting direction, the actual shape of intermediate portion 273 can vary.

First flange 102 extends downwardly from crossing portion 106 of intermediate portion 273. In one embodiment of the invention first flange 102 generally forms an angle with respect to crossing portion 106 of about 90°. Other embodiments of the invention are contemplated, as disclosed and illustrated herein, wherein crossing portion 106 and first flange portion 271 have other angles with respect to each other. First flange 102 is capable of implementation in a wide variety of shapes and orientations with respect to crossing portion 106.

First flange 102 engages frame 400 of screen and frame assembly 255. In the embodiment illustrated in FIG. 7 first flange 102 has a downwardly (according to the orientation illustrated in FIG. 7) extending dimension of about 5 mm (millimeters). However, the invention is not limited in this regard. In some embodiments of the invention, the inner perimeter of a frame of the screen and frame assembly includes a recessed portion. In that case, first flange 102 extends downwardly to an extent sufficient for secure disposition of first flange 102 into the recessed portion of the frame.

Body portion 124 extends generally downwardly (according to the orientation illustrated in FIG. 7) from crossing portion 106. Some embodiments of the invention include a second flange 120 extending inwardly from body portion 124. That is, flange 272 extends from body portion 124 in the direction of bezel 400.

Crossing portion 106, in cooperation with first flange 102, and body portion 124, bind the frame to the bezel. Therefore, according to embodiments of the invention, crossing portion 106 is of a length dimension 251 sufficient to traverse the portion of the frame between first flange 102 and the bezel, and the bezel itself. All such embodiments are intended to lie within the scope of the invention. While example dimensions are provided in this specification, actual dimensions will vary due to the variety of cabinet sizes and frame and bezel dimensions used in the manufacture of various display devices. Therefore, the length of crossing portion 106 can vary. Any length for crossing portion 106 that is sufficient to cross the portion of the frame engaged by first flange 102 and the outer surface of the bezel, while maintaining the frame in contact with the bezel, is intended to remain within the scope of the invention.

First flange 102, crossing portion 106 and body portion 124 secure the frame, at least partially, by providing maintaining the frame and the bezel in a closely fitted relationship. Therefore, the length dimension for crossing portion 106 (illustrated in limits the distance between first flange 102 and body portion 124 to a first distance when the fastener is in an uninstalled position. As the fastener is installed, it is rotated about the frame and bezel such that the first distance would not allow complete rotation of the fastener into an installed position. Therefore, according to embodiments of the invention, fastener 270 is constructed, at least in part, of a deformably resilient material.

The deformably resilient material permits an installer to engage first flange 102 with frame 202 and then deform at least a portion of the remaining portions of the fastener such that the remaining portions can be positioned for installation. In one embodiment of the invention, crossing portion 106 comprises deformable material having a resilience sufficient to allow outward deflection of portions of fastener 270 to a degree sufficient to allow body portion 124 to be placed in contact with outer surfaces of bezel 400. This will be explained and illustrated in more detail below.

Further embodiments of the invention include fasteners having alternative shapes, to the shape illustrated in FIG. 7. Embodiments including shapes that confer additional advantages are described herein. For example, embodiments of the invention include fasteners having shapes that provide ease of installation of the fasteners. As another example, fasteners according to various embodiments of the invention avoid interference of the fastener with the displayed image. Mechanical interference, such as reflecting light from the fastener onto screen 200 during the displaying of video images on screen 200 is an undesirable effect. Therefore, embodiments of the invention include fasteners having shapes that minimize the reflection of light from the fastener onto the screen 200.

Fasteners according to some embodiments of the invention are formed from a continuous elongated strip of resilient material, such as spring steel. Nonetheless, the invention is not limited in this regard. Other suitable materials may be used. According to one embodiment of the invention, fasteners are formed by bending the elongated strip into the shapes depicted in the drawings according to various embodiments of the invention.

Fasteners according to embodiments of the invention comprises a cold-reduced high carbon steel strip. This type of strip is one of many types useful for its spring properties. Cold-rolled steel is typically produced from pickled hot-rolled coils by cold reduction to the desired thickness. This production process allows thinner gages to be produced than those provided by other processes. This production process further provides a better surface finish and better dimensional control than those provided by other processes.

Various embodiments of the invention comprise steel produced in a quality selected from the group comprising commercial quality (CQ) steel, drawing quality(DQ) steel, or drawing quality, special killed (DQSK) steel. In one embodiment of the invention the material is supplied annealed to permit stamping and forming. Following forming, the springs are hardened by heat treatment.

According to one embodiment of the invention fastener 100 comprises at least one portion comprising steel conforming to the chemical composition described by table 1.

TABLE 1

| | Specification | | | | | |
|---|---|---|---|---|---|---|
| | 15250870 | | | | 15250860 | |
| Type | “Regular” Carbon | | | | High Carbon | |
| UNS Grade | G10600 | G10650 | G10700* | G10740* | G10950 | |
| AISI Grade | 1060 | 1065 | 1070 | 1074 | 1095 | |
| Carbon | 0.55-0.66 | 0.59-0.70 | 0.65-0.76 | 0.69-0.80 | 0.90-1.04 | % |
| Manganese | 0.60-0.90 | 0.60-0.90 | 0.60-0.90 | 0.40-0.80 | 0.30-0.50 | % |
| Phosphorous | ≦0.40 | ≦0.40 | ≦0.40 | ≦0.40 | ≦0.40 | % |
| Sulfur | ≦0.50 | ≦0.50 | ≦0.50 | ≦0.50 | ≦0.50 | % |
| Iron | Balance | Balance | Balance | Balance | Balance | |

For some embodiments of fasteners of the invention, the carbon, manganese, phosphorus or sulfur content does exceed that specified by table 1 by more than about 25 percent. In embodiments comprising “regular” carbon steel spring portions, fastener 100 comprises the composition designated on Table 1 by specification number 15250870. Various embodiments of the invention use UNS grades G10740 or G10700. For embodiments of fasteners of the invention wherein higher-stress springs are desired, the composition designated on Table 1 by specification number 15250860 is useful. Use of specification number 15250860 allows up to about 10% higher stresses than embodiments comprising other compositions identified on Table 1.

Some embodiments of fasteners of the invention comprise at least one fastener portion comprising steel containing carbon in an amount ranging from about 0.55% to about 1.04%. For some embodiments, the steel further contains manganese in a content raging from about 0.30% to about 0.60%. In one embodiment of the invention no minimum amounts of other alloying elements are provided in the at least one fastener portion. In one embodiment of the invention at least one portion of the strip comprising the fastener is annealed so as to permit forming operations.

Various embodiments of fasteners according to the invention comprise at least one fastener portion possessing mechanical properties such as those generally given by the examples in Table 2. Values provided in Table 2 are approximate and useful as a guide in constructing various embodiments of fasteners of the invention.

TABLE 2

| Specification | 15250870 | 15250860 | Units |
|---|---|---|---|
| Tensile Strength | 1100-2200 | 1240-2340 | MPa (ksi) |
| | (160-320) | (180-340) | |
| Elastic Modulus | 210 (30) | 210 (30) | GPa (psi × 10⁶) |
| Hardness, HRB | ≦85 | ≦88 | annealed |

Values shown on Table 2 are suitable for heat treated and tempered embodiments of fastener 100, except as noted in the table. It is important to note the values on Table 2 are provided for guidance in accordance with particular embodiments of the invention. Actual properties of embodiments of the invention will vary depending, for example, on thickness and heat treatment. Such dependencies are known to those of ordinary skill in the art of forming steel.

A fastener according to one embodiment of the invention, in an annealed condition, is capable of withstanding bending, at room temperature, around a diameter equal to its thickness, through an angle of 180° when the bend axis is perpendicular to the rolling direction, without cracking of the fastener. Some fasteners according to embodiments of the invention are capable of withstanding similar bending around a diameter equal to twice the fastener thickness when the bend axis is parallel to the rolling direction.

It is further important to note that the material comprising the various embodiments of fasteners of the invention is not limited to steel. Other embodiments will be devised comprising other materials, for example plastic. Suitable materials include, but are not limited to, materials possessing the tensile strength, hardness and elastic modulus described generally on Table 2. According to one embodiment of the invention the fastener is not less than about 0.50 inches (12.7 mm) in width.

FIG. 8 illustrates an alternative embodiment of a fastener 100 according to the invention. The embodiment of fastener 100 will be described herein as it relates to a screen and frame assembly 255 generally corresponding to that illustrated in FIG. 14. Turning to FIG. 14, a partial cross sectional view of one embodiment of screen and frame assembly 255 according to the invention is illustrated in detail. The frame 202 includes a first recess, in the illustrated embodiment a U-shaped portion 300, which receives screen 200. According to some embodiments of the invention, the frame 202 also includes a second recessed portion, for example U-shaped portion 302. Frame surfaces 304, 306 and 308 contact the bezel when the frame 202 and screen 200 are inserted into the bezel. Surface 310 and surface 312 of the second U-shaped portion 302 contact the first flange 102 of the fastener 100 illustrated in FIG. 8.

According to one embodiment of the invention, a recess 314 is defined in the second U-shaped portion 302 to facilitate installation of the fastener 100. In one embodiment, the first flange includes a tip portion configured to extend into the recess, as is discussed in further detail below.

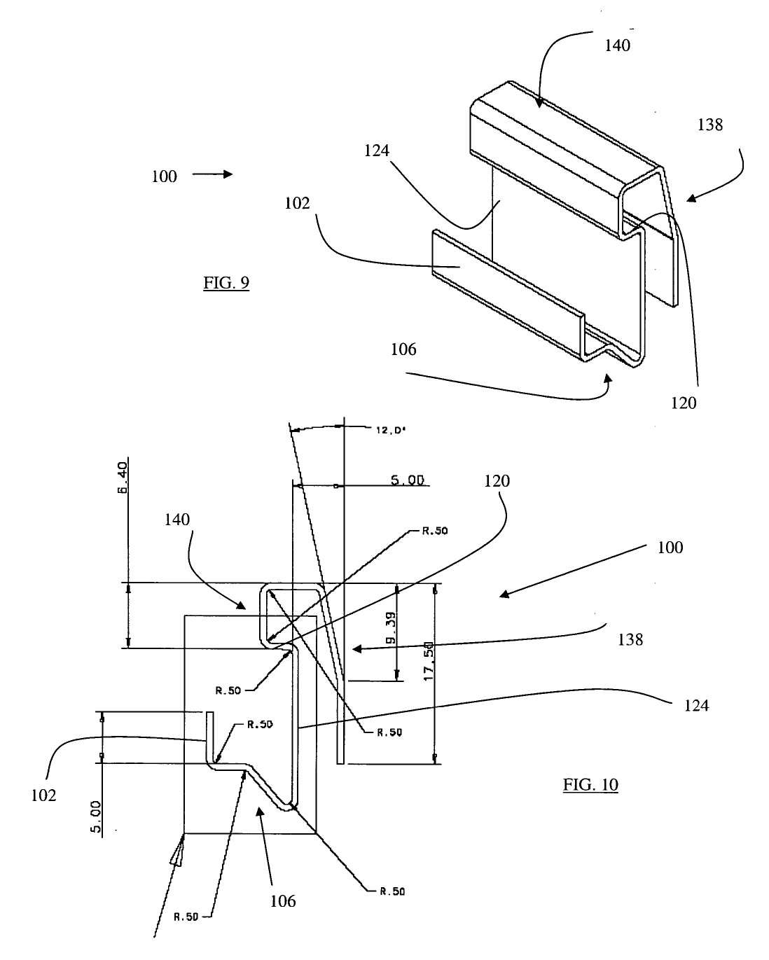

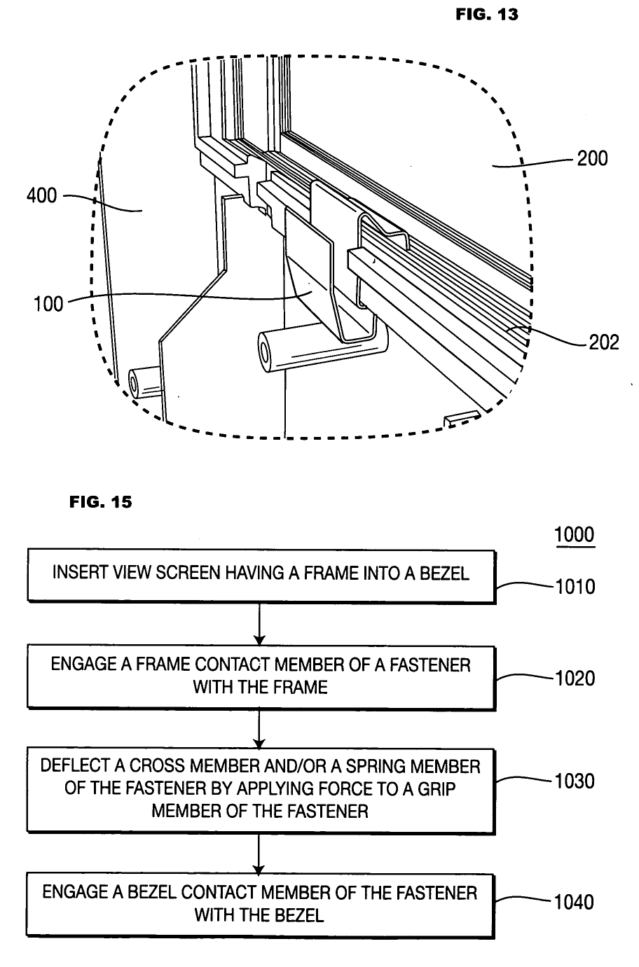

As previously described, fastener 100 includes a first flange 102. The first flange 102 defines a first planar surface for engaging at least a portion of the frame 202 of the screen and frame assembly. First flange 102 includes a first surface 104 and a second surface 105 that contact frame 202. In one embodiment of the invention, the first flange 102 is substantially planar and has a shape that is generally rectangular. FIG. 11 illustrates one alternative embodiment of the invention wherein first flange 102 includes a flange tip 402. In this embodiment flange tip 402 is shaped so as to further engage frame 202.

Returning to FIG. 14, fastener 100 also includes a crossing portion 106. In one embodiment of the invention crossing portion 106 comprises a resiliently deformable material as described above. According to one embodiment of the invention, the crossing portion extends between and connects the first flange 102 and the body portion 124. The crossing portion 106 extends at least for a distance sufficient to maintain at least a portion of the screen assembly in contact with at least a portion of the bezel after installation of the fastener. Example dimensions for crossing portion 106, first flange 102, body portion 124 are provided in FIG. 10. In one embodiment of the invention, crossing portion 106 includes a bend 108 that defines a first portion 110 and a second portion 112 of crossing portion 106. According to one embodiment of the invention, bend 108 forms an angle between the first portion 110 and the second portion 112 in the range of about 1100 to about 160°. However the invention is not limited to embodiments wherein crossing portion 106 includes a bend 108.

According to one embodiment of the invention, the first portion 110 and the second portion 112 of the crossing portion 106 both are substantially planar and each of the portions 110, 112 have a shape that is generally rectangular. A first side 114 of the first portion 110 is connected to a first side 116 of the first flange 102 by a bend 118 defined along a continuous length of each of the sides 114,116. The first portion 110 of the crossing portion 106 is approximately perpendicular to the first flange 102.

Fastener 100 further includes a second flange 120 having a bezel contacting surface 122 that contacts the bezel 400. According to one embodiment of the invention, the second flange 120 is substantially planar and has a shape that is generally rectangular. According to one embodiment of the invention, the second flange 120 is generally parallel to crossing portion 106. According to alternative embodiments of the invention, second flange 120 is not parallel to crossing portion 106.

A body portion 124 extends between crossing portion 106 and second flange 120. According to one embodiment of the invention, body portion 124 forms a bend (best illustrated in FIG. 11 at 806 ) with crossing portion 106 where the body portion and the crossing portion meet. A first side 128 of the body portion 124 is connected to a first side 130 of the second portion 112 of the crossing portion 106 along a continuous length of each of the sides 128, 130. In addition, the body portion 124 is connected to the second flange 120 by a bend 132. Specifically, a second side 134 of the body portion 124 is connected to a first side 136 of the second flange 120 along a continuous length of each of the sides 134,136. The body portion 124 is substantially planar and has a shape that is generally rectangular. In one embodiment of the invention body portion 124 is resiliently biased and substantially parallel to the first flange 102. The body portion 124 and the crossing portion 106 connect the first flange 102 and the second flange 120 to secure the view screen into the bezel, as is discussed below in further detail.

According to embodiments of the invention, fastener 100 further comprises a handle portion 138. In an example embodiment of the invention, the handle portion 138 is substantially planar and has a shape that is generally rectangular. The handle portion 138 is substantially parallel to the body portion 124. The handle portion 138 is manipulate, for example, to deflect the body portion 124 and the crossing portion 106 to facilitate installation of the fastener 100 into the video apparatus to secure the view screen into the bezel.

According to one embodiment of the invention, a handle support member 140 is connected between the second flange 120 and the handle portion 138. The handle support member 140 includes bend 142 and bend 144 to define a first portion 146, a second portion 148 and a third portion 150. The first portion 146, second portion 148 and third portion 150 of the handle support member 140 all are substantially planar and each of the portions 146, 148 and 150 have a shape that is generally rectangular.

The first portion 146 of the handle support member 140 is connected to the second flange 120 by a bend 152. In particular, a first side 154 of the first portion 146 of the handle support member 140 is connected to a second side 156 of the second flange 120 along a continuous length of each of the sides 154, 156. Further, the third portion 150 of the handle support member 140 is connected to the handle portion 138 by a bend 158. Specifically, a first side 160 of the third portion 150 is connected to a first side 162 of the handle portion 138 along a continuous length of each of the sides 160, 162.

The first portion 146 of the handle support member 140 is approximately perpendicular to the second flange 120. Further, the second portion 148 of the handle support member 140 is approximately perpendicular to the first portion 146, and is generally parallel to the second flange 120. The bend 144 forms an angle between the second portion 148 of the handle support member 140 and the third portion 150 in the range of 90° to 135°.

FIG. 8 is an enlarged partial view of a rear portion of the view screen 200, frame 202 and bezel 400 depicting the fastener 100 being installed to secure the frame 202, and hence the view screen 200, to the bezel 400. Referring both to FIG. 4 and FIG. 2, bezel surface 502 engages frame surface 304, bezel surface 504 engages frame surface 306, and bezel surface 506 engages frame surface 308.

During installation, the fastener 100 is aligned with a notch 800 defined in a bezel support member 802. A plurality of such notches 800 are defined in the support member 802 to provide an indication of desired placement if each of the plurality of fasteners 100 to be installed.

Referring both to FIG. 8 and FIG. 3, the first flange 102 of the fastener 100 is inserted into the U-shaped portion 302 of the frame 202. Moreover, the first flange 102 can extend into the recess 314 of the frame 202. The handle portion 138 of the fastener 100 is depressed to deflect the body portion 124 and the crossing portion 106 to facilitate installation of the fastener 100 onto the frame 202 and the bezel 400. FIG. 9 is an enlarged partial view of a rear portion of the view screen 200, frame 202 and bezel 400 depicting the fastener 100 as installed.

FIG. 10 is a flow chart useful for understanding a method 1000 of installing the fastener. At step 1010, the view screen and frame are inserted into the bezel. At step 1020, the first flange of the fastener is engaged with the frame. At step 1030, the crossing portion and/or the body portion of the fastener are deflected by applying force to the handle portion of the fastener. At step 1040, the second flange of the fastener is engaged with the bezel.

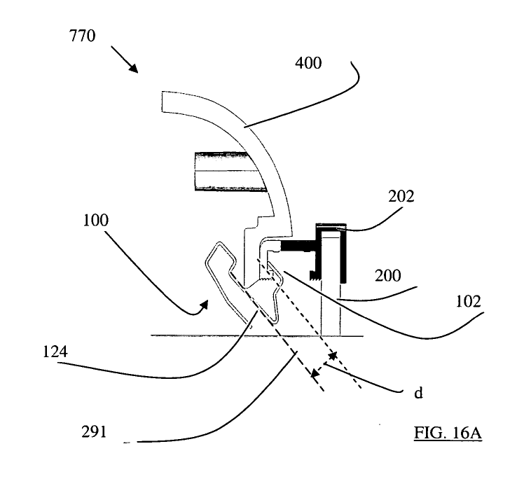

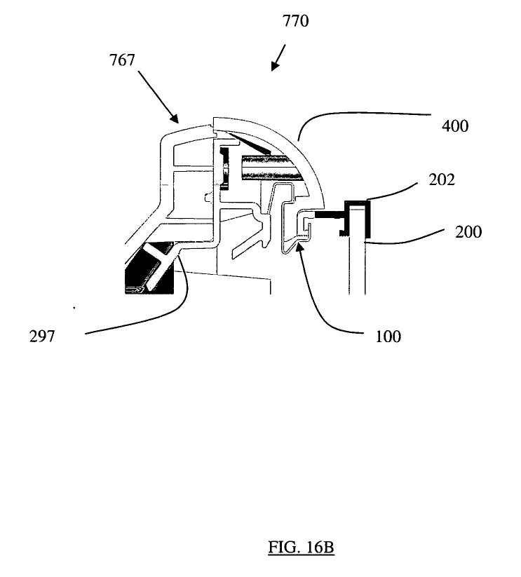

FIGS. 16A and 16B illustrates a side elevation view of fastener 100 in relation to frame 202 and bezel 400. As illustrated in the figures the portion of frame 202 in contact with first flange 102 of fastener 100 defines a first cross sectional width of frame 202. The portion of the bezel 400 contacted by the body portion 124 defines a second cross sectional width of bezel 400. The sum of first and second cross sectional widths are illustrated at 291. The combined cross sectional widths define a distance d (indicated by arrows). The fastener 100 illustrated in FIG. 16A is shown as it appears during rotation of the fastener during installation. At the position illustrated, fastener 100 is in a first position, that is, undeformed. Further rotation of the fastener 100 beyond the position illustrated relies on deformation of fastener 100 from the first position to a second position in order to continue rotatation during installation and to traverse the combined cross section. Therefore, further rotation results in increasing distance d.

FIG. 16B illustrates fastener 100 in an installed position, that is, in position after rotation and installation are completed. As can be seen from the illustration, fastener 100 is resiliently reformed to its first position upon completion of rotation into the second, installed position. Resilience of the material comprising fastener 100 reforms fastener 100 to its first position.

The present invention may, of course, be carried out in other specific ways than those herein set forth without departing from the spirit and essential characteristics of such invention. The present embodiments are, therefore, to be considered in all respects as illustrative and not restrictive, and all changes coming within the meaning and equivalency range of the appended claims are intended to be embraced therein.

1. A fastener for fastening a screen assembly to a bezel for a display device cabinet, said fastener comprising:
a first flange defining a first planar surface for engaging at least a first portion of said screen assembly;
a body portion defining a second planar surface for engaging at least a first portion of said bezel,
said first planar surface substantially parallel and spaced apart from said second planar surface by a first distance when said fastener is in an initial position;
a crossing portion extending between and connecting said first flange and said body portion, said crossing member extending for a distance sufficient to maintain at least a portion of said screen assembly in contact with at least a portion of said bezel after installation of said fastener;
at least one of said flange, said body portion and said crossing portion comprising a resiliently deformable material such that said fastener is deformable from said initial position to a second position during installation of said fastener, and reformable to said initial position after said installation.

2. The fastener of claim 1 wherein said screen assembly comprises a display screen fitted within a frame.

3. The fastener of claim 1 wherein said flange, said body portion and said crossing portion are formed from a generally elongated strip comprising a resiliently deformable material.

4. The fastener of claim 1 wherein said resiliently deformable material comprises spring steel.

5. The fastener of claim 1 further comprising a second flange extending generally perpendicularly from said body portion in the direction of said bezel said second flange engaging at least a second portion of said bezel.

6. The fastener of claim 5 further comprising a flange tip portion extending at an angle from said first flange, said flange tip engaging a second frame portion.

7. The fastener of claim 5 further comprising a manually engageable member connected to said fastener such that said fastener is capable of being deformed from said initial position to said second position by manual operation of said manually engageable member during installation of said fastener.

8. The fastener of claim 7 wherein said manually engageable member comprises a handle portion and a handle supporting portion, said handle supporting portion connecting said manually engageable member to said second flange, said handle portion defining a third planar surface generally parallel to and spaced from said second planar surface.

9. The fastener of claim 8 wherein said handle portion is spaced from said second planar surface and oriented with respect to said bezel so as to allow manipulation of said handle portion by an assembler during installation of said fastener.

10. The fastener of claim 1 wherein said portion of said screen assembly engaged by said first flange defines a first cross section having a first width, wherein said portion of said bezel engaged by said body portion defines a second cross section having a second width, wherein the sum of said first and second widths approximately equals said first distance, wherein said fastener is deformable to increase said first distance to a second distance such that said first and second cross sections are traversable by said fastener during rotation of said fastener during installation.

11. The fastener of claim 1 wherein said body portion extends toward a central longitudinal axis of said cabinet by a distance sufficient to at least partially reflect light projected toward said screen away from said screen, and wherein said bend is sufficient to prevent light from reflecting from said crossing member toward said screen.

12. The fastener of claim 1 wherein said crossing portion defines a slope between said body portion and said first flange when said fastener is in said second position, said slope preventing light from deflecting from said crossing portion onto said screen during operation of said display device.

13. The fastener of claim 1 wherein said screen is free of penetrating affixing devices.

14. A method for fastening a screen assembly to a bezel of a display device comprising steps of:
fitting said screen assembly within said bezel to form at least one screen assembly and bezel cross section;
engaging at least a portion of said screen assembly with a first flange of a resiliently deformable fastener;
while said first flange is engaged, rotating said fastener while deforming at least one of a crossing portion and a body portion of said fastener such that said body portion of said fastener traverses said cross section; and
continuing rotation until a second flange of said fastener engages with said bezel.

15. The method of claim 14 wherein said screen assembly comprises a screen and a frame.

16. The method of claim 14, wherein said deforming step is performed including a step of manipulating a manually engageable member of said fastener.

17. The method of claim 16, wherein said manipulating step further comprises applying a force via said manually engageable member to deform said fastener

18. The method of claim 14 wherein the method is performed without the use of screws penetrating said screen.

19. A method of mounting a display screen assembly including a frame to a cabinet of a television set without penetrating said display screen by affixing devices, comprising the steps of:
providing a plurality of resiliently deformable fasteners, each fastener comprising a body portion extending between first and second flanges;
for each fastener:
engaging said first flange with a portion of said frame;
rotating said fastener to engage said second flange with said cabinet such that said display screen is secured to said cabinet.

20. The method of claim 19 wherein the method is performed without the use of screws penetrating the screen of said display screen assembly.
